(19) United States
(12) Patent Application Publication
(10) Pub. No.: US 2009/0050366 A1
(43) Pub. Date: Feb. 26, 2009

(54) Arrangement for Current Distribution and Contact Arrangement and Fuse Protection Thereof of the Outgoing Cables

(75) Inventors: Franz-Josef Lietz, Oberhausen-Lirich (DE); Rainer Mackel, Konigswinter (DE); Thomas Schulz, Unterensingen (DE)

Correspondence Address: BROMBERG & SUNSTEIN LLP, 125 SUMMER STREET, BOSTON, MA, 02110-1618, US

(73) Assignee: AUTO KABEL MANAGEMENTGESELLSCHAFT MBH, Hausen i.W. (DE)

(21) Appl. No.: 12/281,272

(22) PCT Filed: Mar. 1, 2007
(86) PCT No.: PCT/EP2007/001741

§ 371 Date: Oct. 10, 2008

(30) Foreign Application Priority Data
Mar. 3, 2006 (DE) 10 2006 009 936.2

(51) Int. Cl. H01R 4/00

(52) U.S. Cl. 174/72 R

(57) ABSTRACT

The invention relates to a potential distribution system for motor vehicles, which makes provision for a reserve on contact bars of an excess number of connection possibilities for further outlets. The connection possibilities which are not required can be closed off with a blanking plug and the connection possibilities which are required are brought in contact by means of an intermediate element, wherein the intermediate element can be designed as a fuse box or as an intermediate plug with integrated fuses.

The invention relates to a potential distribution system for motor vehicles, with which existing cable harnesses can be made slimmer.

High-current distribution in motor vehicles is effected as a rule by means of flexible or highly flexible circular cables or leads which are grouped together in bundles. These types of cable harnesses are flexibly slack and therefore often require an additional cable duct of stable form. The contact arrangement for cable harnesses can only be put into effect at fixed predetermined outlets from the cable harness and from the cable duct if present. As a rule, interim access is not possible, or only with very high effort and expenditure, since it is not provided in terms of design and is not desired.

In individual cases, pre-shaped rigid elements are used for bracing the cable harness. One example of this is known from the Siemens Patent Specification DE 3609704 C2. The bracing is achieved in this case by additional shaped elements made of plastic, onto which the cable harness is bound. The contact arrangements of the individual cables of the cable harness are provided at specially designed outlets or at plug connections provided in the design layout.

Likewise, with halogen lights for the lighting of rooms in buildings, potential distribution systems for 12 V DC are known. In order to meet the requirements for the very widely differing spatial distribution arrangements in buildings, in this case flexible distribution systems are proposed which have been made up beforehand. An example of such a potential distribution system is known from DE 10017484 C2. In this case, the potential distribution is put into effect with a bar plugging system. The circuit conductor structure in this case is located on a plastic carrier of the individual bar segments. The bar segments are connected among one another by connection elements to form the desired overall layout of the potential distribution system. Connection of the halogen lights is intended to be put into effect by means of plug connectors, which, in a comparable manner to the connection elements, are attached to the ends of the bar segments.

Also known is the use of connection boxes or distribution boxes for contact bars. In EP 0722200 B1, for example, it is proposed that plug connection possibilities be provided on a bar system for branching cable harnesses. The housing of the bar system and the plug connection possibilities are in this case manufactured from an artificial resin, such that the plug possibility can be cast together with the plastic housing of the bar system. Also previously known, according to EP 0722200 B1 are distribution boxes from a plastic housing, wherein the distribution box is simultaneously designed as a fuse box.

In on-board networks of motor vehicles, bar systems as a substitute for the cable harness have hitherto remained unknown. This may be attributable in particular to the higher costs of bar systems.

However, the known bar systems also offer too few advantages for use in motor vehicle on-board networks. The main disadvantage is the deficient flexibility, still perceived as inadequate, in respect of outlet possibilities. In particular, the fuse securing of the outgoing cables often does not allow for any flexibility with the known bar systems. It is precisely this, however, which is desirable for the on-board networks in these motor vehicles for retrofitting with additional consuming components or for handling the different equipment alternatives of such motor vehicles.

The object according to the invention is therefore to propose a bar system which is especially suitable for potential distribution in motor vehicles.

The solution is provided by a potential distribution system according to claim 1. Further embodiments are disclosed in the sub-claims and in the following description.

The solution is provided mainly by a bar system which makes provision for a reserve on the contact bars of an excess number of connection possibilities for further outlets. The connection possibilities which are not required can be closed off with a blanking plug and the connection possibilities which are required are brought in contact by means of an intermediate element, wherein the intermediate element can be designed as a fuse box or as an intermediate plug with integrated fuses.

The bar system can also be designed as a double bar system. One bar can then be used as an earth return. The bar system is then especially well-suited for the utility vehicle sector, in which on-board networks with earth returns are used.

Embodiments are explained in greater detail hereinafter on the basis of figures.

The Figures show:

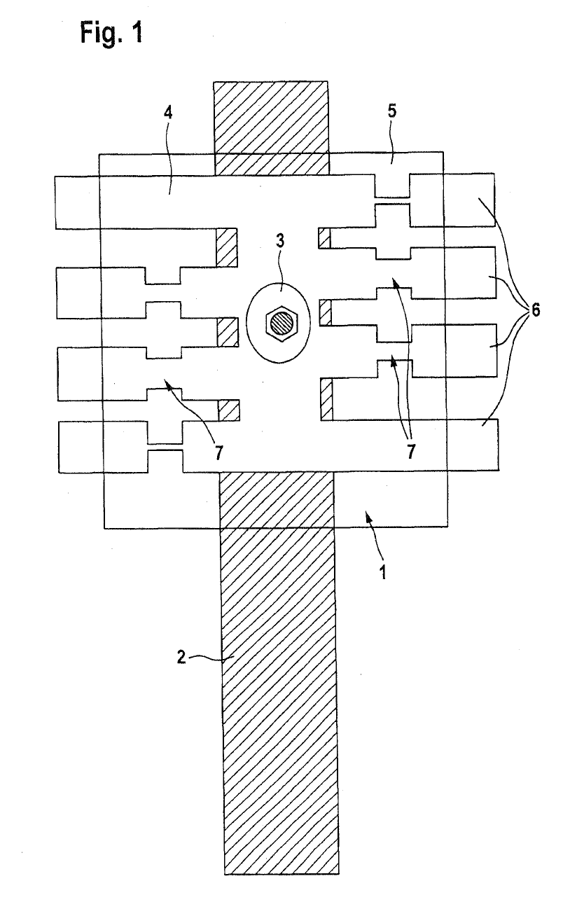

FIG. 1 A first embodiment with a screw-connectable intermediate element,

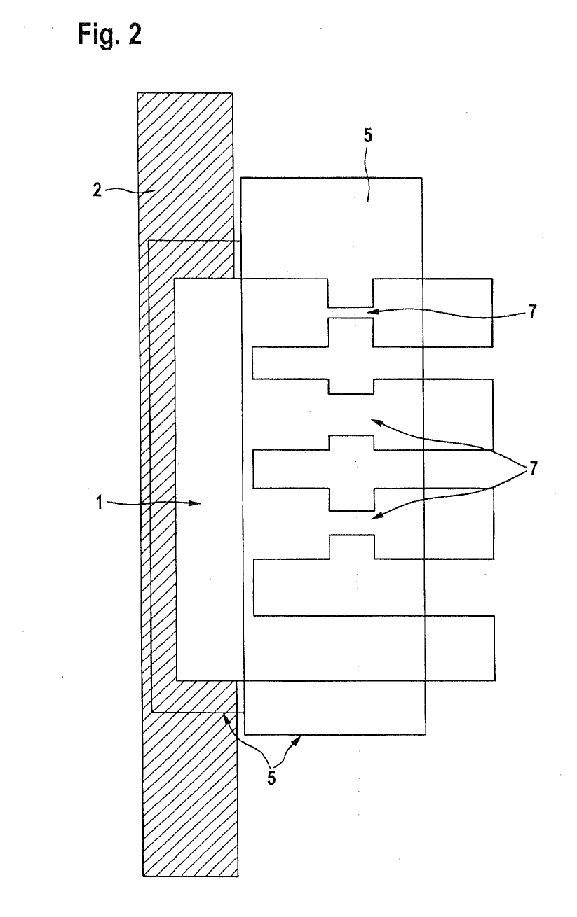

FIG. 2 A further embodiment with a pluggable intermediate element,

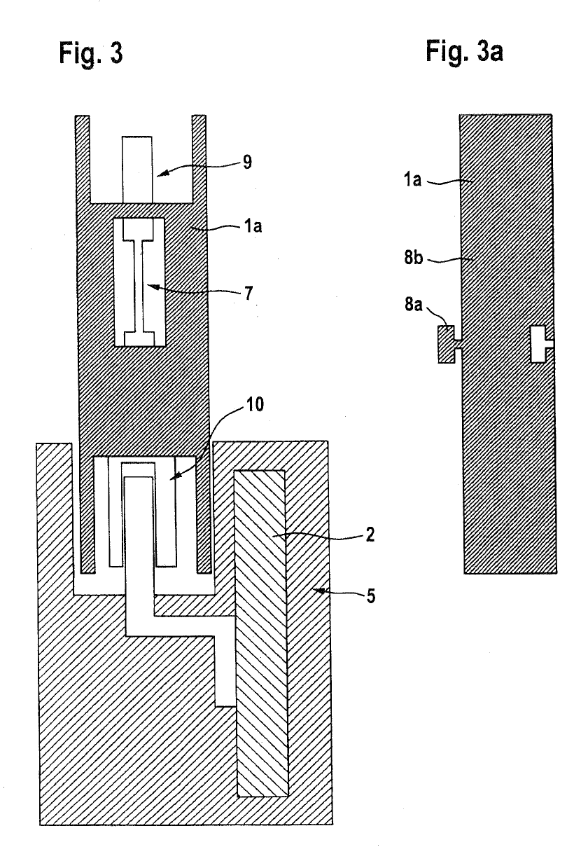

FIG. 3 A further embodiment with an intermediate plug,

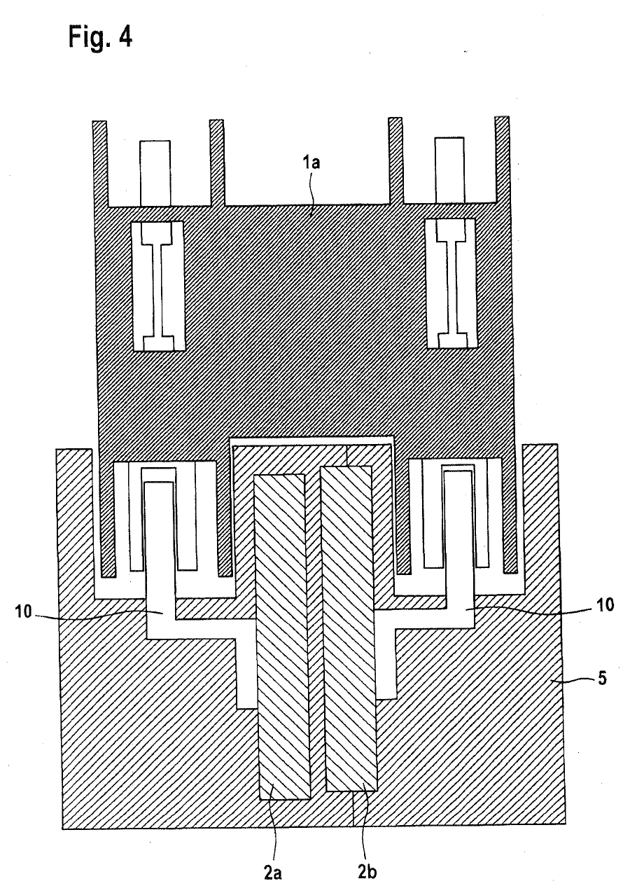

FIG. 4 An embodiment for a double bar system,

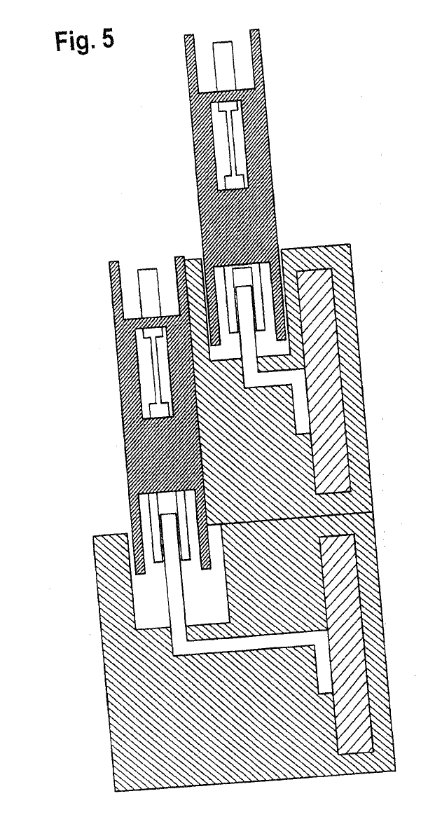

FIG. 5 A further embodiment for a double bar system.

FIG. 1 shows a first embodiment of the potential distribution system, in which an intermediate element 1 is formed as a fuse box, and wherein the intermediate element is contacted via a screw connection 3 to the contact bar 2. The screw connection is preferably used when the contact bar runs on the underfloor area of a motor vehicle and through-contacting takes place through the underfloor. This can be the case at the end of the bar but also along the course of the run. The screw connection is connected to the bar in material-joining fashion, e.g. by welding a threaded bolt into the contact bar. The intermediate element contains a metallic stamped grid 4 which is integrated into a housing 5. The stamped grid is formed by a plurality of electrical current branches 6. If required, a fuse element 7 can at the same time also be contained in the individual current branches, preferably as a cross-section tapering element in the current outlet branch of the stamped grid.

FIG. 2 shows another embodiment, in which the contacting of the intermediate element 1 is effected by means of a plug connection to the contact bar 2. Depending on the anticipated current loading, one or more contact lugs are located on the bar in material-joining fashion, e.g. by welding, clinching, soldering, etc. The outgoing direction of these contacts is preferably rotated through 90° in relation to the direction of run of the bar. These contact lugs are preferably already surrounded by injection with a moulding compound of plastic following on from the manufacturing process of the potential distribution system. This serves on the one hand to provide insulation and to protect the contact lugs, while on the other the surround injection can also be used as a plug housing, which is of significance in connection with the subsequent embodiments. The contact lug can in this context be one-part or multi-part in the output section. With multi-part outputs, the protective housing 5 is advantageously divided up into a plurality of chambers. If, depending on the configuration variant, not all the contacts are used, the unused chambers or contacts can be closed off with a blanking plug.

FIG. 3 shows an embodiment in which the intermediate element is designed as an intermediate plug 1a. The intermediate plug then also contains the fuse box In this situation the box can consist of individual fuse elements 7. It is also possible for a plurality of current branches to be integrated into the intermediate plug. It is also possible for a plurality of individual intermediate plugs to be connected to one another by way of their housings. These individual intermediate plugs la can then, as shown in the partial representation in FIG. 3a, be connected to one another by clips or a plug device which are introduced as matching plug elements 8a and cut-out apertures 8b onto or into the intermediate plug housing. In this way it is also possible for retro-fittings to be carried out by the removal of blanking plugs on the unused bar-side plug elements for the intermediate plugs and the use of additional intermediate plugs, or for variants to be covered.

The cable set for the consuming components to be connected is then simply fitted on the output side to a contact lug 9 of the intermediate plug. The contact arrangement of the intermediate plug with the contact bar likewise takes place by means of a plug-in contact lug 10. The housing of the bar-side contact lug 10 and the housing la of the intermediate plug engage in one another in a precise fit, and can additionally be formed with an engagement function, which supports the reliable mechanical retention of the plug connection.

The intermediate plug with the integrated fuses can naturally also be designed as one-piece with a plurality of parallel current branches, e.g. as a stamped grid solution.

A further embodiment of the potential distribution system is represented in FIG. 4. In this case, the potential distribution system is designed as a double bar system. In this case, two bars 2a, 2b are contacted simultaneously by an intermediate element, which in FIG. 4 is designed as an intermediate plug 1a. The two contact bars 2a, 2b to be contacted can in this situation preferably be integrated into a housing 5. To do this, the contact lugs 10 going out from the contact bars are located on different sides of the bars, one on the top of the bar 2a and one below on the other bar 2b. The potentials of these bars can be connected, for example with the standardised terminal 30, i.e. the input from the positive pole of the battery, and the potential from the terminal 15, i.e. the output to the ignition or driving switch, or the in-circuit terminal 30. In this case, fuses are located on the top side or the bottom side.

As an alternative, the potential distribution can be selected on both the contact bars in such a way that one contact bar lies on the potential from the terminal 30, while the other contact bar lies on the potential from the terminal 31, i.e. the return lead to the battery or negative pole or earth to the battery. Such an earth return is used, for example, in the on-board networks of utility vehicles. In this situation it would be sufficient if a fuse were to be integrated at the connection of the contact bar to the potential of the terminal 30 and a second fuse in the earth current path can be dispensed with.

If, with a multi-bar arrangement, it is not desirable for the contact bars to be grouped together as a double bar system, it is naturally also possible for two individual bars to be laid next to one another with separated housings in each case. This situation is represented in FIG. 5. Preferably, the two contact bar housings to be laid next to one another are matched to one another in such a way that, for example, the housing of the one contact bar projects in height over the housing of the other bar, in such a way as to establish contact between the contact bars and an intermediate plug in the area of the projecting height. This is the case in particular if this projecting height is greater than the height of the intermediate plug.

Instead of intermediate elements or intermediate plugs, it is of course also possible for control devices to be connected directly to the bar system.

It is also possible for two or more bars to be inserted in one plane, as a result of which a plurality of potentials can then also be divided. In this situation, the connection lugs can be arranged either laterally offset or above one another.

1-6. (canceled)

7. Motor vehicle potential distribution system comprising:
a potential conducting contact bar system with a contact bar,
wherein a reserve of an excess number of connection possibilities for further outlet is provided at the contact bar,
wherein an intermediate element is connected to the contact bar,
wherein the consuming components to be connected can be connected to the intermediate element, and
wherein the intermediate element is designed as an intermediate plug with a plurality of respective integrated fuses, having the current branches forming the outlets.

8. Potential distribution system if claim 7, wherein the bar system is designed as a double bar system.

9. Potential distribution system of claims 7, wherein the contact lugs in the intermediate element are designed as stamped grids.

10. Potential distribution system of claims 9, wherein the contact lugs of the intermediate element and the connection of the contact lugs to the contact bars are cast in a common housing.

11. Potential distribution system of claims 7, further comprising a multi-bar system, wherein contact bar housings are matched to one another.

12. Potential distribution system of claim 11, wherein one contact bar housing projects over the other contact bar housing by at least the height of an intermediate plug.
